(19) United States
(12) Patent Application Publication
(10) Pub. No.: US 2004/0252524 A1
(43) Pub. Date: Dec. 16, 2004

(54) Illuminated collar

(76) Inventor: Walter R. Dacheux JR., Athens, TN (US)

Correspondence Address: Mr. Walter J. Tencza Jr., Suite 3, 10 Station Place, Metuchen, NJ, 08840, US

(21) Appl. No.: 10/457,897

(22) Filed: Jun. 10, 2003

(51) Int. Cl. F21L 4/00

(52) U.S. Cl. 362/570

(57) ABSTRACT

An apparatus is disclosed having a hollow tube having first and second ends, the first end attached to the second end to form a ring. An electrical light or a plurality of electrical lights may be located inside the hollow tube. The apparatus may include a battery for powering the electrical light. An elastic sleeve may be provided which surrounds the battery and holds the battery to the hollow tube. The one or more electrical lights may each include a light housing and a light bulb. The apparatus may have a first covering attached to an outside of the hollow tube. The first covering may at least partially cover the hollow tube so that the light housing and the light bulb are at least partially obscured. The first covering allows at least some light from the electrical light to be emitted through the first covering.

### FIELD OF THE INVENTION

This invention relates to improved methods and apparatus concerning illuminated collars.

### BACKGROUND OF THE INVENTION

Various illuminated pet collars are known in the prior art. For example, U.S. Pat. No. 5,046,456 to Heyman et. al., incorporated by reference herein, discloses an illuminated collar 10 having a hollow tube 12. (Heyman, FIG. 1; col. 2, Ins. 9-28). A string of lights 16 is enclosed in the tube 12. (Id.) A housing 18 is provided which includes conventional batteries for powering the string of lights. (Id.) The housing 18 is attached to one end of tube 12 by a retaining ring 24. (Id. at Ins. 30-32). The retaining ring 24 is attached to the tube 12 by a screw. (Id. at col. 2, In. 65-col. 3, In. 1). The size of the collar 10 is adjustable by the use of a strap 32 and buckle holes 34. (Heyman, col. 2, Ins. 45-48).

### SUMMARY OF THE INVENTION

The present invention in one or more embodiments provides an apparatus comprising a hollow tube having first and second ends, the first end attached to the second end to form a ring or collar. An electrical light or a plurality of electrical lights may be located inside the hollow tube. The apparatus may include a battery for powering one or more electrical lights. An elastic sleeve may be provided which surrounds the battery and holds the battery to the hollow tube.

The one or more electrical lights may each include a light housing and a light bulb. The apparatus may be further comprised of a first covering attached to an outside of the hollow tube. The first covering may at least completely cover the hollow tube so that the light housing and the light bulb are at least partially obscured. The first covering allows at least some light from the electrical light to be emitted through the first covering. The apparatus may be further comprised of a second covering, wherein the second covering covers the elastic sleeve and battery.

The present invention in one or more embodiments includes a method comprising the steps of placing an electrical light inside a hollow tube, attaching a first end of the hollow tube to a second end of the hollow tube to form a ring, attaching a battery to an outside of the hollow tube by the use of an elastic sleeve, and electrically connecting the battery to the electrical light so that the battery can power the electrical light.

### BRIEF DESCRIPTION OF THE DRAWINGS

FIG. 1 shows a perspective view of an apparatus in accordance with an embodiment of the present invention;

FIG. 2 shows a perspective view of the apparatus of FIG. 1 along with a first and a second covering attached to the apparatus; and

FIG. 3 shows a perspective view of the apparatus of FIG. 1 which shows the location of lights within the apparatus.

### DETAILED DESCRIPTION OF THE DRAWINGS

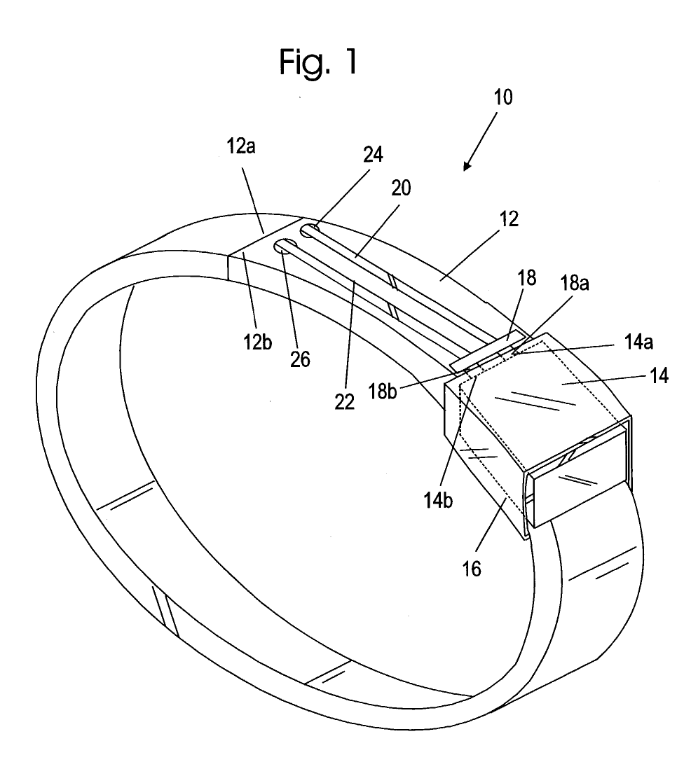

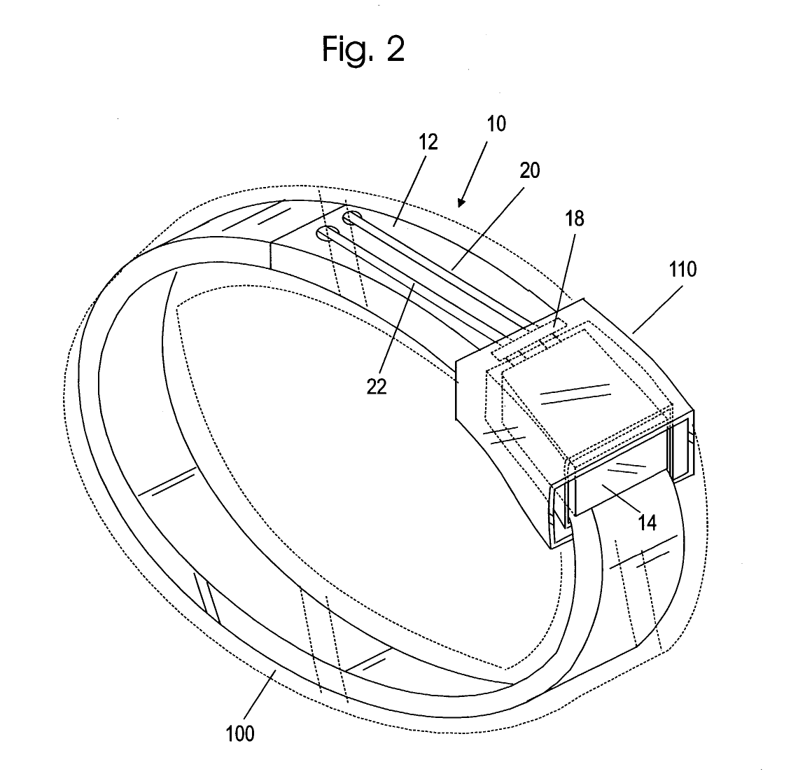

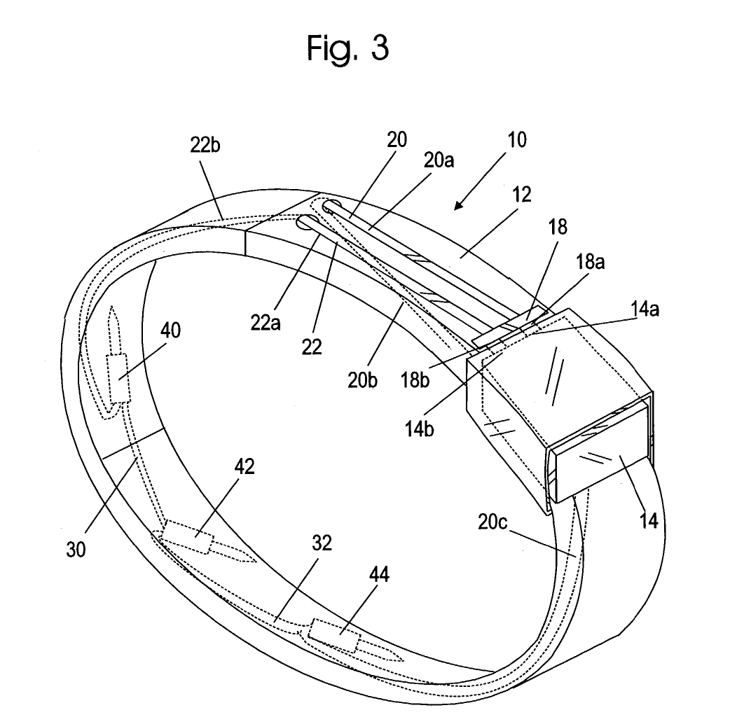

FIG. 1 shows a perspective view of an apparatus 10 in accordance with an embodiment of the present invention. FIG. 2 shows a perspective view of the apparatus 10 of FIG. 1 along with a first covering 100 shown by dashed lines and a second covering 110 shown by solid lines, attached to the apparatus 10. FIG. 3 shows a perspective view of the apparatus 10 of FIG. 1 which shows the location of lights 40, 42, and 44 within the apparatus 10.

The apparatus 10 is comprised of a hollow tube 12 having ends 12a and 12b. The tube 12 is shown in FIG. 1 as somewhat rectangular in shape, however, the tube 12 may be another shape, such as round or cylindrical. The ends 12a and 12b are attached together in any manner to form a closed loop or ring. The hollow tube 12 may be transparent, however, the components within the hollow tube 12 are omitted in FIG. 1 to simplify description. The apparatus 10 is also comprised of a battery 14, sleeve 16, a battery connector 18, and wires 20 and 22.

Wires 20 and 22 are electrically connected to terminals 18a and 18b of battery connector 18. Terminals 18a and 18b are electrically connected to terminals 14a and 14b of battery 14. The sleeve 16 may be made of an elastic material which holds the battery 14 at the location on the outside of the tube 12 shown in FIG. 1.

As shown by FIG. 3, the apparatus 10 also includes lights 40, 42, and 44, wire portions 22b, and 20c, and wires 32, and 30, which are typically inside the tube 12. The lights 40, 42, and 44, wire portions 22b and 20c, and wires 32 and 30 are shown by dashed lines in FIG. 3 to simplify description, however, typically these components can be seen through the tube 12, if the tube 12 is transparent.

The terminal 14a of the battery 14 is electrically connected to terminal 18a of the battery connector 18. The terminal 18a of the battery connector 18 of electrically connected to a wire portion 20a of the wire 20 as shown by FIG. 3. The wire portion 20a is electrically connected to a wire portion 20b which goes under or around the battery 14 (i.e. is not directly connected to the battery 14) and is electrically connected to wire portion 20c. The wire portion 20c is electrically connected to one terminal, such as a positive terminal, of light 44. A second terminal of light 44, such as a negative terminal, is electrically connected to wire 32. Wire 32 is electrically connected to a first terminal, such as a positive terminal of light 42. A second terminal of light 42, such as a negative terminal, is electrically connected to wire 30. Wire 30 is electrically connected to a first terminal, such as a positive terminal of light 40. A second terminal of light 40, such as a negative terminal is electrically connected to wire portion 22b which is electrically connected to wire portion 22a. Wire portion 22a is electrically connected to terminal 18b which is electrically connected to terminal 14b of the battery 14 completing a circuit.

The wires, such as wires 20, 22, 30, and 32 may include a conductor and insulation covering the conductor.

Referring to FIG. 2, a material or first covering 100, shown by dashed lines, may be used to cover the tube 12 and/or the entire apparatus 10. The material 100 may be a mesh, net, or ribbon like material which allows light to come through the material 100 but which makes it more difficult to see the wires, such as wires 20, 22, 30, and 32, and the light housings and bulbs, such as light housing 42a and light bulb 42b of light 42. In this way the hardware within the tube 12 is at least partially hidden while the light is allowed to be transmitted through the material 100.

Also referring to FIG. 2, a material or second covering 110, shown by solid lines, may be used to cover the sleeve 16 and/or the battery 14, so as to hide the sleeve 16 and/or the battery 14.

The apparatus 10, with or without the first covering 100 or the second covering 110, can be slipped over the head of a pet, such as a dog or cat, or the head of a human being. The apparatus 10 in various embodiments is typically not adjustable. The battery 14 may be a nine volt battery. The lights 40, 42, and 44 may be turned on by connecting the terminals 18a and 18b of the battery connector or cap 18 with the terminals 14a and 14b respectively, of the battery 14. The lights 40, 42, and 44 may be turned off by disconnecting the terminals 18a and 18b of the battery connector or cap 18 from the battery terminals 14a and 14b, respectively.

The first covering 100 may be a larger tube in which the tube 12 is inserted, or the first covering 100 may be a ribbon or other material which is wrapped around the tube 12 and glued to the tube 12.

In at least one embodiment of the present invention, the apparatus 10 has no clips, hooks, or buckles. The apparatus 10 does not need to be attached to a leash.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a hollow tube having first and second ends, the first end attached to the second end to form a ring;
an electrical light inside the hollow tube;
a battery for powering the electrical light;
an elastic sleeve; and
wherein the elastic sleeve surrounds the battery and holds the battery to the hollow tube.

2. The apparatus of claim 1 wherein
the electrical light has a light housing and a light bulb; and
further comprising a first covering attached to the outside of the hollow tube;
wherein the first covering at least partially covers the hollow tube so that the light housing and the light bulb are at least partially obscured; and
wherein the first covering allows at least some light from the electrical light to be emitted through the first covering.

3. The apparatus of claim 2 further comprising
a second covering; and
wherein the second covering covers the elastic sleeve.

4. The apparatus of claim 1 further comprising
a first covering; and
wherein the first covering covers the elastic sleeve.

5. A method comprising the steps of:
placing an electrical light inside a hollow tube;
attaching a first end of the hollow tube to a second end of the hollow tube to form a ring;
attaching a battery to an outside of the hollow tube by the use of an elastic sleeve; and
electrically connecting the battery to the electrical light so that the battery can power the electrical light.

6. The method of claim 5 further comprising
attaching a first covering to the outside of the hollow tube;
wherein the first covering at least partially covers the hollow tube so that a light housing and a light bulb of the electrical light are at least partially obscured; and
wherein the first covering allows at least some light from the electrical light to be emitted through the first covering.

7. The method of claim 6 further comprising
placing a second covering over the elastic sleeve.

8. The method of claim 5 further comprising
placing a second covering over the elastic sleeve.
